(19) United States
(12) Patent Application Publication
(10) Pub. No.: US 2018/0016187 A1
(43) Pub. Date: Jan. 18, 2018

(54) Titanium-ruthenium co-doped vanadium dioxide thermosensitive film material and preparation method thereof

(71) Applicant: University of Electronic Science and Technology of China, Chengdu (CN)

(72) Inventors: Deen Gu, Chengdu (CN); Shiyang Xu, Chengdu (CN); Yadong Jiang, Chengdu (CN)

(73) Assignee: University of Electronic Science and Technology of China

(21) Appl. No.: 15/719,129

(22) Filed: Sep. 28, 2017

(30) Foreign Application Priority Data
Sep. 8, 2017 (CN) 201710803109.2

(51) Int. Cl. C03C 17/245

(52) U.S. Cl. CPC C03C 17/245; C03C 2218/32; C03C 2218/31; C03C 2217/218; C03C 2217/24; C03C 2218/154

(57) ABSTRACT

A titanium-ruthenium co-doped vanadium dioxide thermosensitive film material and a preparation method thereof are provided, which relate to a technical field of uncooled infrared detectors and electronic films. The vanadium dioxide thermosensitive film material is prepared by using titanium and ruthenium as co-dopants, including a substrate and a titanium-ruthenium co-doped vanadium dioxide layer, wherein in the titanium-ruthenium co-doped vanadium dioxide layer, atomic percentages of the titanium, the ruthenium and the vanadium are respectively 4.0-7.0%, 0.5-1.5% and 25.0-30.0%, and a balance is the oxygen. The present invention also provides a preparation method of a titanium-ruthenium co-doped vanadium dioxide thermosensitive film material, including a step of using a titanium-ruthenium-vanadium alloy target as a source material and using a reactive sputtering method, or using a titanium target, a ruthenium target and a vanadium target as sputtering sources and using a co-reactive sputtering method.

### CROSS REFERENCE OF RELATED APPLICATION

The present invention claims priority under 35 U.S.C. 119(a-d) to CN 201710803109.2, filed Sep. 8, 2017.

### BACKGROUND OF THE PRESENT INVENTION

### Field of Invention

The present invention relates to a technical field of infrared detectors and electronic films, particularly to a vanadium dioxide thermosensitive film material and a preparation method thereof, and more particularly to a co-doped vanadium dioxide thermosensitive film material with no phase transition, a low resistivity, as well as a high temperature coefficient of resistance, and a preparation method thereof.

### Description of Related Arts

Uncooled infrared focal plane array detector has advantages such as small size, light weight and high sensitivity because no cooler is used, and has a wide range of applications in forest-fire prevention, security, power inspection, medical and other fields. In order to improve the detection distance of the device and reduce the manufacturing cost, pixel size of the uncooled infrared focal plane array detector has gradually decreased from the initial 45 μm to 12 μm (R. A. Wood, et al., IEEE, 1992, 132-135; A. Rogalski, et al., 2016, Rep. Prog. Phys., 79, 046501). However, reducing the pixel size will result in an increase in the noise equivalent temperature difference (NETD) of the device (A. Rogalski, et al., 2016, Rep. Prog. Phys., 79, 046501). The higher the NETD is, the lower the sensitivity of the device will be. On the other hand, the higher the temperature coefficient of resistance (|TCR|) of the thermosensitive film used in the device is (the TCR of the semiconductor material is generally negative; when describing the TCR, if no special instructions, a TCR value refers to an absolute value of |TCR|), the smaller the NETD as well as the greater the sensitivity of the device will be. Therefore, the use of high TCR thermosensitive film helps to develop uncooled infrared focal plane array detector with high sensitivity and small pixel. Mixed valence vanadium oxide (VOₓ) has advantages such as: (a) high TCR, (b) low noise, (c) proper room temperature resistivity (0.5-5 Ω·cm), (d) good compatibility with microelectromechanical system (hereinafter referred to as “MEMS”)process, and (e) good compatibility with integrated circuit process, so the material is widely used as a thermosensitive material for uncooled focal plane array. Such mixed valence vanadium oxide film generally has a TCR of 2.0-2.5%/° C. (R. A. Wood, et al., IEEE, 1992, 132-135; S. H. Black, et al., Proc. of SPIE, 2011, 8012, 80121 A). VOₓ film generally has an amorphous structure, wherein in the high temperature environment, such amorphous structure has a tendency to crystallize. Once crystallization happens, electrical parameters of the film will be significantly changed. Thus, the amorphous nature of the VOₓ film constrains the process windows of the subsequent MEMS techniques.

In order to further improve the sensitivity of the device, a VO₂ film with a monoclinic structure is also used as a thermosensitive material for the uncooled infrared focal plane array. Compared with VOₓ film, the VO₂ film with monoclinic structure not only has a relatively stable crystal structure, but also has a higher TCR, especially in the semiconductor-metal phase transition, wherein a phase transition interval TCR can be as high as 16%/° C. or more. However, the VO₂ film with monoclinic structure faces three problems as the thermosensitive material for the uncooled focal plane array: first, thermal hysteresis phenomenon during phase transition of the VO₂ film with monoclinic structure means a high thermal hysteresis noise, and the thermal hysteresis noise will significantly increase the device noise and reduce a signal to noise ratio; second, the temperature of the subsequent processes (PECVD process for dielectric layer, etching process, release process, etc.) after thermosensitive film deposition in the manufacture of the uncooled focal plane array device is much larger than a phase transition temperature of the VO₂ film (about 68° C.), which means that the VO₂ film will undergo multiple phase transitions during manufacture, and such the phase transition is accompanied by a volume change, wherein multiple volume changes will inevitably reduce the reliability of multilayer films for a pixel bridge of the uncooled focal plane array; third, the VO₂ film has a high room temperature resistivity (>10 Ω·cm), which not only restricts the design of the pixel structure, but also limits the choice of the operating parameters of the device. Therefore, VO₂ film with monoclinic structure is difficult to be really used as a to thermosensitive film for developing of high performance uncooled infrared focal plane array device.

Therefore, in order to meet the needs for the thermosensitive film for developing uncooled infrared focal plane array detectors, it is significantly important to develop crystallized vanadium dioxide thermosensitive film material with no phase transition, low resistivity, and high temperature coefficient of resistance.

### SUMMARY OF THE PRESENT INVENTION

An object of the present invention is to provide a novel vanadium dioxide thermosensitive film material with advantages such as a monoclinic structure, no phase transition, low resistivity, as well as a high temperature coefficient of resistance, and a preparation method thereof, wherein the preparation method is compatible with a MEMS process of an uncooled infrared focal plane array detector, and is adaptable to batch fabrication of such device.

Accordingly, in order to accomplish the above object, the present invention provides:

a titanium-ruthenium co-doped vanadium dioxide thermosensitive film material, wherein titanium and ruthenium are used as co-dopants for preparing the titanium-ruthenium co-doped vanadium dioxide thermosensitive film material.

Preferably:

the titanium-ruthenium co-doped vanadium dioxide thermosensitive film material comprises a substrate and a titanium-ruthenium co-doped vanadium dioxide layer, wherein the titanium-ruthenium co-doped vanadium dioxide layer is deposited on the substrate, comprising the titanium, the ruthenium, vanadium and oxygen; wherein atomic percentages of the titanium, the ruthenium and the vanadium are respectively 4.0-7.0%, 0.5-1.5% and 25.0-30.0%, and a balance is the oxygen.

Preferably:

the substrate is a high-purity quartz substrate, a Si substrate with a SiO₂ film, a Si substrate with a SiNₓ film, or a K9 glass substrate.

The present invention also provides two preparation methods of the titanium-ruthenium co-doped vanadium dioxide thermosensitive film material, both using titanium and ruthenium as co-dopants for preparing the vanadium dioxide thermosensitive film material with no phase transition, a low resistivity and a high temperature coefficient of resistance.

### Embodiment 1

using a titanium-ruthenium-vanadium alloy target as a source material and using a reactive sputtering method for preparing the vanadium dioxide thermosensitive film material with no phase transition, the low resistivity and the high temperature coefficient of resistance, which specifically comprises steps of:

1) pre-heating a substrate in vacuum for 40-400 min at 100-150° C.;

2) pre-sputtering the titanium-ruthenium-vanadium alloy target in a pure argon atmosphere for 5-15 min with a working pressure of 0.5-1.5 Pa;

3) in an atmosphere with an oxygen-argon flow ratio of 1:15-1:30, depositing a titanium-ruthenium co-doped vanadium oxide layer on the substrate pre-heated in the step 1) by sputtering the titanium-ruthenium-vanadium alloy target under a working pressure of 1.5-2.5 Pa, wherein a deposition time depends on a deposition rate and a desired film thickness; and

4) annealing the titanium-ruthenium co-doped vanadium oxide layer deposited in the step 3) in an oxygen-enriched atmosphere with an oxygen-argon flow ratio of 2:1-1:0, a vacuum chamber pressure of 1.0-3.0 Pa, an annealing temperature of 350-400° C., and an annealing time of 30-90 min; then obtaining the titanium-ruthenium co-doped vanadium dioxide thermosensitive film material after annealing.

Preferably:

in the titanium-ruthenium-vanadium alloy target, atomic percentages of the titanium and the ruthenium is 6.0-9.0% and 1.0-3.0%, and a balance is vanadium.

### Embodiment 2

using a titanium target, a ruthenium target and a vanadium target as sputtering sources and using a co-reactive sputtering method for preparing the vanadium dioxide thermosensitive film material with no phase transition, the low resistivity and the high temperature coefficient of resistance, which specifically comprises steps of:

1) pre-heating a substrate in vacuum for 40-400 min at 100-150° C.;

2) respectively pre-sputtering the titanium target, the ruthenium target and the vanadium target in a pure argon atmosphere for 5-15 min with a working pressure of 0.5-1.5 Pa;

3) in an atmosphere with an oxygen-argon flow ratio of 1:20-1:35, synchronously sputtering the titanium target, the ruthenium target and the vanadium target under a working pressure of 1.0-2.0 Pa, so as to deposit a titanium-ruthenium co-doped vanadium oxide layer on the substrate pre-heated in the step 1), wherein a deposition time depends on a deposition rate and a desired film thickness; and

4) annealing the titanium-ruthenium co-doped vanadium oxide layer deposited in the step 3) in an oxygen-enriched atmosphere with an oxygen-argon flow ratio of 5:1-1:0, a vacuum chamber pressure of 1.5-3.0 Pa, an annealing temperature of 350-400° C., and an annealing time of 30-90 min; then obtaining the titanium-ruthenium co-doped vanadium dioxide thermosensitive film material after annealing.

Preferably:

the substrate is a high-purity quartz substrate, a Si substrate with a SiO₂ film, a Si substrate with a SiNₓ film, or a K9 glass substrate.

Preferably:

purities of the titanium target, the ruthenium target and the vanadium target are no less than 99.0%.

The present invention has the following beneficial effects:

1, Monoclinic crystal structure: X-ray diffraction (XRD) analysis confirms that the titanium-ruthenium co-doped vanadium dioxide thermosensitive film material prepared according to the preparation method of the present invention has a monoclinic structure, which avoids process limits caused by conventional amorphous VOₓ film.

2, No phase transition: compared to non-doped vanadium dioxide film, the resistivity-temperature plot of titanium-ruthenium co-doped vanadium dioxide thermosensitive film prepared according to the preparation method of the present invention has no phase transition characteristic, which avoids negative influence caused by phase transition of the non-doped vanadium dioxide film as a thermosensitive film.

3. Low resistivity: the titanium-ruthenium co-doped vanadium dioxide thermosensitive film material prepared according to the preparation method of the present invention has a low room temperature resistivity (1.0-3.5 Ω·cm), less than one third of that of the non-doped vanadium dioxide film, and close to the room temperature resistivity of the VOₓ film, which facilitates more flexible design of pixel structure and selection of device operating parameters.

4, High TCR: the titanium-ruthenium co-doped vanadium dioxide thermosensitive film material prepared according to the preparation method of the present invention has a high TCR (>3.2%/° C.), wherein the TCR is not only higher than that of the non-doped vanadium dioxide film, but also significantly higher than TCR (2.0-2.5%/° C.) of the conventional VOₓ thermosensitive film, which is conducive to improving the sensitivity of an uncooled infrared focal plane array detector.

5. The method for preparing the titanium-ruthenium co-doped vanadium dioxide thermosensitive film material of the present invention is the reactive sputtering method or the co-reactive sputtering method, which is easy to be realized by a conventional sputtering apparatus or an appropriately-improved apparatus, and is compatible with MEMS techniques.

### BRIEF DESCRIPTION OF THE DRAWINGS

In order to more clearly illustrate the technical solution of the embodiments of the present invention, the drawings described as follows are merely some embodiments of the present invention, and for those with ordinary skills in the art, additional drawings are able to be obtained with the hint of the following drawings without paying creative work.

FIG. 1.1-1 is a resistivity-temperature plot of a vanadium dioxide thermosensitive film sample VO-11 obtained in a preferred embodiment 1.1.

FIG. 1.1-2 is an XRD pattern of the vanadium dioxide thermosensitive film sample VO-11 obtained in the preferred embodiment 1.1.

FIG. 1.2-1 is a resistivity-temperature plot of a vanadium dioxide thermosensitive film sample VTRO-12 obtained in a preferred embodiment 1.2.

FIG. 1.2-2 is an XRD pattern of the vanadium dioxide thermosensitive film sample VTRO-12 obtained in the preferred embodiment 1.2.

FIG. 1.3-1 is a resistivity-temperature plot of a vanadium dioxide thermosensitive film sample VTRO-13 obtained in a preferred embodiment 1.3.

FIG. 1.3-2 is an XRD pattern of the vanadium dioxide thermosensitive film sample VTRO-13 obtained in the preferred embodiment 1.3.

FIG. 1.4-1 is a resistivity-temperature plot of a vanadium dioxide thermosensitive film sample VTRO-14 obtained in a preferred embodiment 1.4.

FIG. 1.4-2 is an XRD pattern of the vanadium dioxide thermosensitive film sample VTRO-14 obtained in the preferred embodiment 1.4.

FIG. 2.1-1 is a resistivity-temperature plot of a vanadium dioxide thermosensitive film sample VTRO-21 obtained in a preferred embodiment 2.1.

FIG. 2.1-2 is an XRD pattern of the vanadium dioxide thermosensitive film sample VTRO-21 obtained in the preferred embodiment 2.1.

FIG. 2.2-1 is a resistivity-temperature plot of a vanadium dioxide thermosensitive film sample VTRO-22 obtained in a preferred embodiment 2.2.

FIG. 2.2-2 is an XRD pattern of the vanadium dioxide thermosensitive film sample VTRO-22 obtained in the preferred embodiment 2.2.

FIG. 2.3-1 is a resistivity-temperature plot of a vanadium dioxide thermosensitive film sample VTRO-23 obtained in a preferred embodiment 2.3.

FIG. 2.3-2 is an XRD pattern of the vanadium dioxide thermosensitive film sample VTRO-23 obtained in the preferred embodiment 2.3.

### DETAILED DESCRIPTION OF THE PREFERRED EMBODIMENT

Referring to the drawings and preferred embodiments, the present invention will be further illustrated.

Contrast:

### Preferred Embodiment 1.1 (Contrast)

pre-heating a Si substrate with a 250 nm SiNₓ film in a sputtering vacuum chamber for 40 min at 100° C.; using a pure vanadium target as a sputtering source, and pre-sputtering the pure vanadium targetin a pure argon atmospherefor 5 min with a working pressure of 0.6 Pa; in an atmosphere with an oxygen-argon flow ratio of 1:20, depositing a vanadium oxide layer on the pre-heated substrate (the Si substrate with the 250 nm SiNₓ film) by sputtering under a working pressure of 1.5 Pa for 50 min; and annealing the vanadium oxide layer in an oxygen-enriched atmosphere with an oxygen-argon flow ratio of 10:1, a vacuum chamber pressure of 1.5 Pa, an annealing temperature of 380° C., and an annealing time of 60 min; then cooling to below 85° C. and taking out a sample for obtaining a non-doped vanadium dioxide film (marked as VO-11) as a contrast sample, so as to determine technical effects of the present invention.

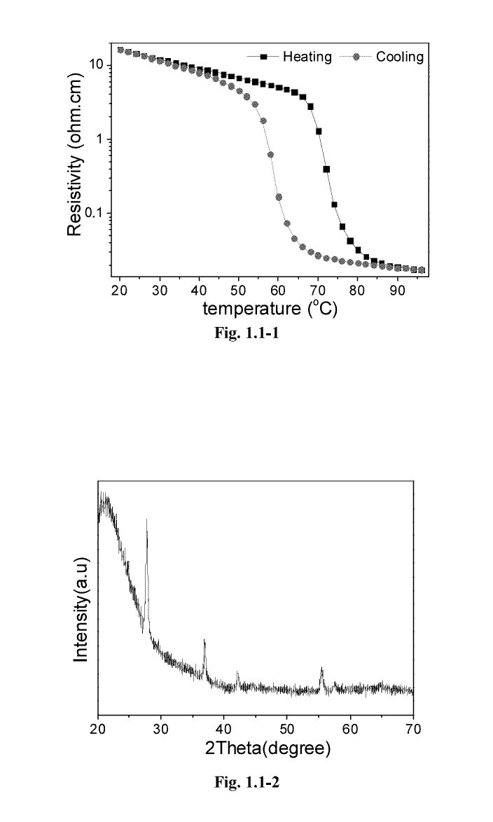

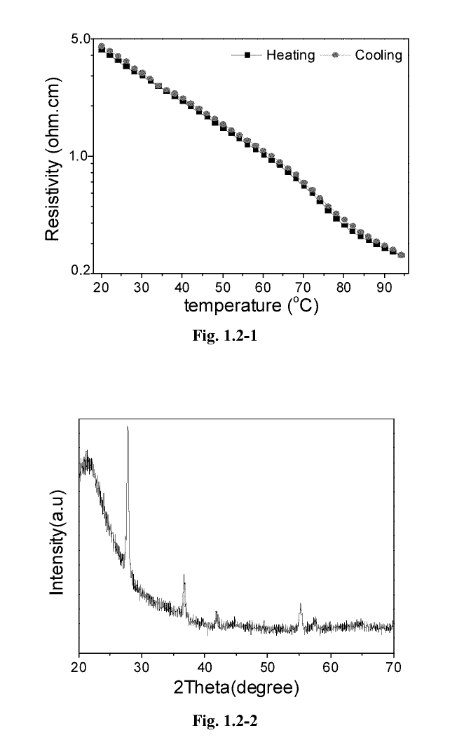

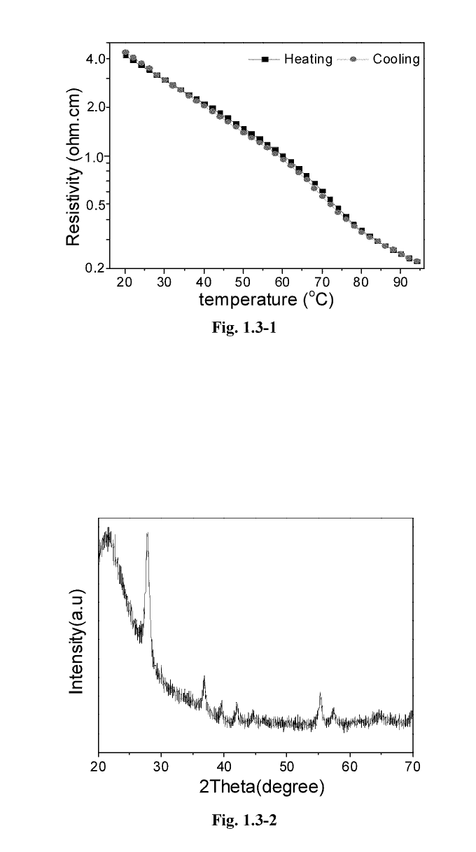

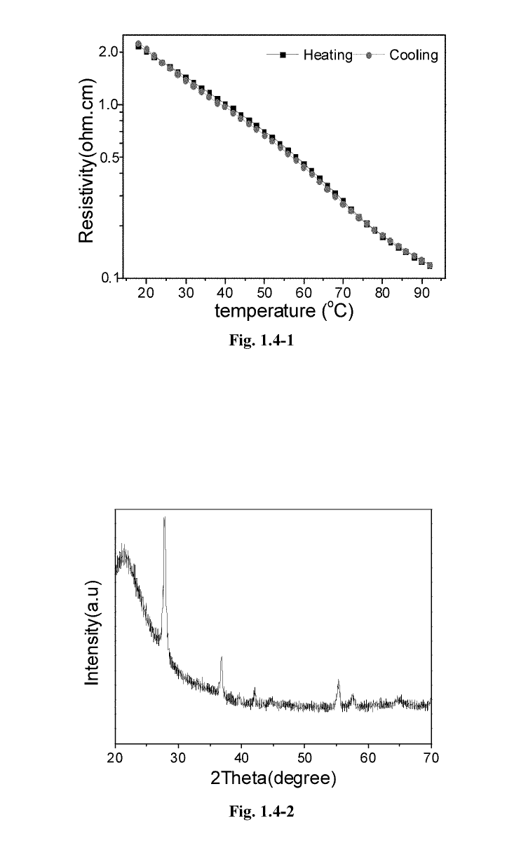

A resistivity (ρ)-temperature (T) plot is obtained for the non-doped vanadium dioxide thermosensitive film sample VO-11by measuring the ρ at different temperature. Referring to FIG. 1.1-1, a resistivity at 30° C. is shown in Table 1.1, wherein according to tested ρ-T data, a temperature coefficient of resistance |TCR| is calculated by a formula

$$TCR = \frac{dln ρ}{dT} .$$

|TCR| at 30° C. is shown in Table 1.1.

TABLE 1.1
parameters of non-doped vanadium dioxide film prepared according to
preferred embodiment 1.1

| sample | \|TCR\| (%/° C.) | Resistivity (Ω · cm) |
|---|---|---|
| VO-11 | 2.8 | 12.0 |

Furthermore, the XRD pattern is recorded for the non-doped vanadium dioxide thermosensitive film sample VO-11. Referring to FIG. 1.1-2, the non-doped vanadium dioxide thermosensitive film sample VO-11 has obvious monoclinic VO₂ diffraction peaks, which means the film is a polycrystalline VO₂ film with a monoclinic structure. Element percentages of the non-doped vanadium dioxide thermosensitive film sample VO-11 are analyzed through energy-dispersive spectrometry (EDS), which are respectively vanadium 34.2% and oxygen 65.8%.

### Embodiment 1

### Preferred Embodiment 1.2

pre-heating a Si substrate with a 250 nm SiNₓ film in a sputtering vacuum chamber for 60 min at 120° C.; using the titanium-ruthenium-vanadium alloy target containing 6.0% titanium and 1.0% ruthenium (atomic percentage), and pre-sputtering a titanium-ruthenium-vanadium alloy target in a pure argon atmosphere for 15 min with a working pressure of 0.5 Pa; in an atmosphere with an oxygen-argon flow ratio of 1:30, depositing a titanium-ruthenium co-doped vanadium oxide layer on the pre-heated substrate (the Si substrate with the 250 nm SiN_{X} film) by sputtering the titanium-ruthenium-vanadium alloy target under a working pressure of 2.5 Pa for 50 min; and annealing the titanium-ruthenium co-doped vanadium oxide layer in an oxygen-enriched atmosphere with an oxygen-argon flow ratio of 1:0, a vacuum chamber pressure of 1.0 Pa, an annealing temperature of 350° C., and an annealing time of 90 min; then cooling to below 85° C. and taking out a sample for obtaining a titanium-ruthenium co-doped vanadium dioxide film (marked as VTRO-12).

A resistivity (ρ)-temperature (T) plot is obtained for the titanium-ruthenium co-doped vanadium dioxide films ample VO-12 by measuring the ρ at different temperature. Referring to FIG. 1.2-1, a resistivity at 30° C. is shown in Table 1.2, wherein according to tested ρ-T data, a temperature coefficient of resistance |TCR| is calculated by the formula

$$TCR = \frac{dln ρ}{dT} .$$

|TCR| at 30° C. is shown in Table 1.2.

TABLE 1.2
parameters of titanium-ruthenium co-doped vanadium dioxide film
prepared according to preferred embodiment 1.2

| sample | \|TCR\| (%/° C.) | Resistivity (Ω · cm) |
|---|---|---|
| VTRO-12 | 3.3 | 3.0 |

It can be concluded that: compared to the non-doped vanadium dioxide thermosensitive film sample (VO-11), semiconductor-metal phase transition of the titanium-ruthenium co-doped vanadium dioxide film sample (VTRO-12) obtained in the preferred embodiment 1.2 is suppressed, wherein no phase transition characteristic is shown, the temperature coefficient of resistance is significantly improved, and the resistivity is significantly reduced.

Furthermore, the XRD pattern is recorded for the titanium-ruthenium co-doped vanadium dioxide film sample VTRO-12. Referring to FIG. 1.2-2, the titanium-ruthenium co-doped vanadium dioxide film sample VTRO-12 has obvious monoclinic VO₂ diffraction peaks, which means the film remains polycrystalline characteristics of the VO₂ film with the monoclinic structure. Element percentages of the titanium-ruthenium co-doped vanadium dioxide film sample VTRO-12 are analyzed through EDS, which are respectively titanium 5.8%, ruthenium 0.5%, vanadium 27.1% and oxygen 66.6%.

### Preferred Embodiment 1.3

pre-heating a Si substrate with a 250 nm SiO₂ film in a sputtering vacuum chamber for 100 min at 100° C.; using the titanium-ruthenium-vanadium alloy target containing 7.5% titanium and 2.0% ruthenium (atomic percentage), and pre-sputtering a titanium-ruthenium-vanadium alloy target in a pure argon atmosphere for 10 min with a working pressure of 1.0 Pa; in an atmosphere with an oxygen-argon flow ratio of 1:25, depositing a titanium-ruthenium co-doped vanadium oxide layer on the pre-heated substrate by sputtering the titanium-ruthenium-vanadium alloy target under a working pressure of 2.0 Pa for 50 min; and annealing the titanium-ruthenium co-doped vanadium oxide layer in an oxygen-enriched atmosphere with an oxygen-argon flow ratio of 2:1, a vacuum chamber pressure of 3.0 Pa, an annealing temperature of 350° C., and an annealing time of 90 min; then cooling to below 85° C. and taking out a sample for obtaining a titanium-ruthenium co-doped vanadium dioxide film (marked as VTRO-13).

A resistivity (ρ)-temperature (T) plot is obtained for the titanium-ruthenium co-doped vanadium dioxide film sample VO-13 by measuring the ρ at different temperature. Referring to FIG. 1.3-1, a resistivity at 30° C. is shown in Table 1.3, wherein according to tested ρ-T data, a temperature coefficient of resistance |TCR| is calculated by the formula

$$TCR = \frac{dln ρ}{dT} .$$

|TCR| at 30° C. is shown in Table 1.3.

TABLE 1.3
parameters of titanium-ruthenium co-doped vanadium dioxide film
prepared according to preferred embodiment 1.3

| sample | \|TCR\| (%/° C.) | Resistivity (Ω · cm) |
|---|---|---|
| VTRO-13 | 3.5 | 2.9 |

It can be concluded that: compared to the non-doped vanadium dioxide thermosensitive film sample (VO-11), semiconductor-metal phase transition of the titanium-ruthenium co-doped vanadium dioxide film sample (VTRO-13) obtained in the preferred embodiment 1.3 is suppressed, wherein no phase transition characteristic is shown, the temperature coefficient of resistance is significantly improved, and the resistivity is significantly reduced.

Furthermore, the XRD pattern is recorded for the titanium-ruthenium co-doped vanadium dioxide film sample VTRO-13. Referring to FIG. 1.3-2, the titanium-ruthenium co-doped vanadium dioxide film sample VTRO-13 has obvious monoclinic VO₂ diffraction peaks, which means the film remains polycrystalline characteristics of the VO₂ film with the monoclinic structure. Element percentages of the titanium-ruthenium co-doped vanadium dioxide film sample VTRO-13 are analyzed through EDS, which are respectively titanium 6.1%, ruthenium 0.6%, vanadium 29.2% and oxygen 64.1%.

### Preferred Embodiment 1.4

pre-heating a quartz substrate in a sputtering vacuum chamber for 40 min at 150° C.; using the titanium-ruthenium-vanadium alloy target containing 9.0% titanium and 3.0% ruthenium (atomic percentage), and pre-sputtering a titanium-ruthenium-vanadium alloy target in a pure argon atmosphere for 5 min with a working pressure of 1.5 Pa;in an atmosphere with an oxygen-argon flow ratio of 1:15, depositing a titanium-ruthenium co-doped vanadium oxide layer on the pre-heated substrate by sputtering the titanium-ruthenium-vanadium alloy target under a working pressure of 1.5 Pa for 50 min; and annealing the titanium-ruthenium co-doped vanadium oxide layer in an oxygen-enriched atmosphere with an oxygen-argon flow ratio of 5:1, a vacuum chamber pressure of 2.0 Pa, an annealing temperature of 400° C., and an annealing time of 30 min; then cooling to below 85° C. and taking out a sample for obtaining a titanium-ruthenium co-doped vanadium dioxide film (marked as VTRO-14).

A resistivity (ρ)-temperature (T) plot is obtained for the titanium-ruthenium co-doped vanadium dioxide film sample VO-14by measuring the ρ at different temperature. Referring to FIG. 1.4-1, a resistivity at 30° C. is shown in Table 1.4, wherein according to tested ρ-T data, a temperature coefficient of resistance |TCR| is calculated by the formula

$$TCR = \frac{dln ρ}{dT} .$$

|TCR| at 30° C. is shown in Table 1.4.

TABLE 1.4
parameters of titanium-ruthenium co-doped vanadium dioxide film
prepared according to preferred embodiment 1.4

| sample | \|TCR\| (%/° C.) | Resistivity (Ω · cm) |
|---|---|---|
| VTRO-14 | 3.5 | 1.4 |

It can be concluded that: compared to the non-doped vanadium dioxide thermosensitive film sample (VO-11), semiconductor-metal phase transition of the titanium-ruthenium co-doped vanadium dioxide film sample (VTRO-14) obtained in the preferred embodiment 1.4is suppressed, wherein no phase transition characteristic is shown, the temperature coefficient of resistance is significantly improved, and the resistivity is significantly reduced.

Furthermore, the XRD pattern is recorded for the titanium-ruthenium co-doped vanadium dioxide film sample VTRO-14. Referring to FIG. 1.4-2, the titanium-ruthenium co-doped vanadium dioxide film sample VTRO-14 has obvious monoclinic VO₂ diffraction peaks, which means the film remains polycrystalline characteristics of the VO₂ film with the monoclinic structure. Element percentages of the titanium-ruthenium co-doped vanadium dioxide film sample VTRO-14 are analyzed through EDS, which are respectively titanium 6.3%, ruthenium 0.9%, vanadium 29.5% and oxygen 63.3%.

### Embodiment 2

### Preferred Embodiment 2.1

pre-heating a Si substrate with a 300 nm SiO₂ film in a sputtering vacuum chamber for 100 min at 100° C.; respectively pre-sputtering a titanium target with a purity of 99.5%, a ruthenium target with a purity of 99.5% and a vanadium target with a purity of 99.5% in a pure argon atmosphere for 15 min with a working pressure of 0.5 Pa; in an atmosphere with an oxygen-argon flow ratio of 1:20, depositing a titanium-ruthenium co-doped vanadium oxide layer on the pre-heated substrate by sputtering under a working pressure of 1.0 Pa for 50 min; and annealing the titanium-ruthenium co-doped vanadium oxide layer in an oxygen-enriched atmosphere with an oxygen-argon flow ratio of 5:1, a vacuum chamber pressure of 1.5 Pa, an annealing temperature of 350° C., and an annealing time of 90 min; then cooling to below 85° C. and taking out a sample for obtaining a titanium-ruthenium co-doped vanadium dioxide film sample (marked as VTRO-21).

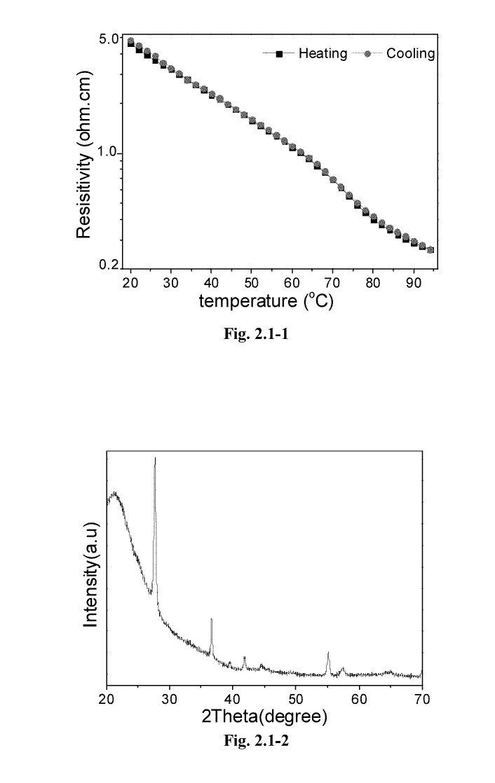

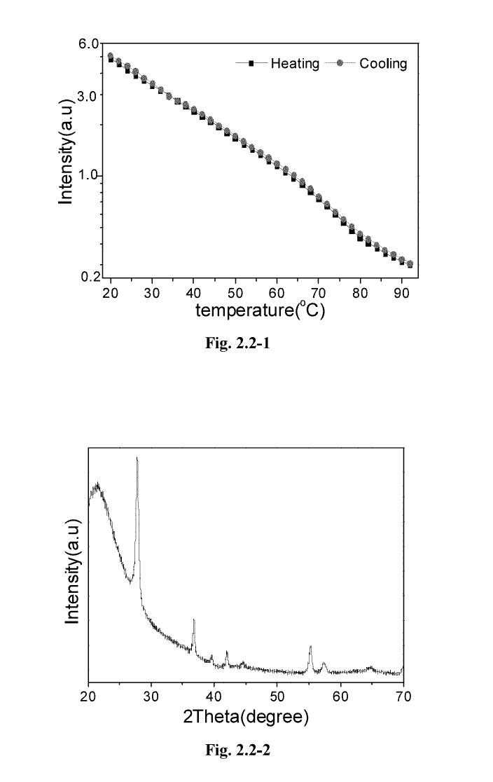

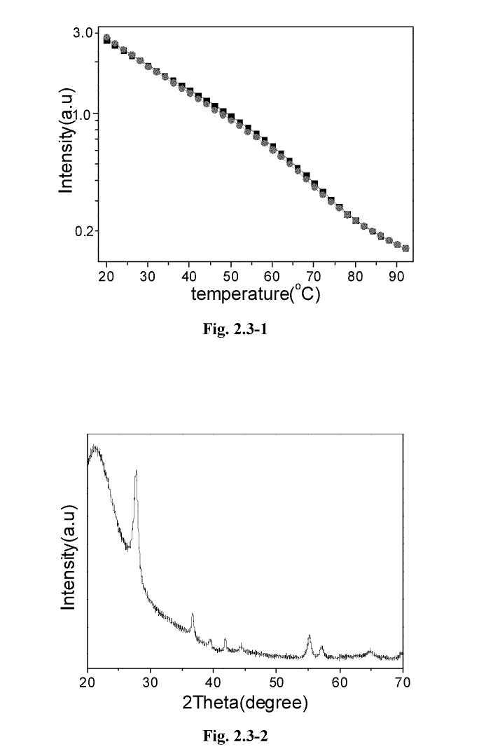

A resistivity (p)-temperature (T) plot is obtained for the titanium-ruthenium co-doped vanadium dioxide film sample VO-21 by measuring the ρ at different temperature. Referring to FIG. 2.1-1, a resistivity at 30° C. is shown in Table 2.1, wherein according to tested ρ-T data, a temperature coefficient of resistance |TCR| is calculated by the formula

$$TCR = \frac{dln ρ}{dT} .$$

|TCR| at 30° C. is shown in Table 2.1.

TABLE 2.1
parameters of titanium-ruthenium co-doped vanadium dioxide film
prepared according to preferred embodiment 2.1

| sample | \|TCR\| (%/° C.) | Resistivity (Ω · cm) |
|---|---|---|
| VTRO-21 | 3.3 | 3.2 |

It can be concluded that: compared to the non-doped vanadium dioxide thermosensitive film sample (VO-11), semiconductor-metal phase transition of the titanium-ruthenium co-doped vanadium dioxide film sample (VTRO-21) obtained in the preferred embodiment 2.1is suppressed, wherein no phase transition characteristic is shown, the temperature coefficient of resistance is significantly improved, and the resistivity is significantly reduced.

Furthermore, the XRD pattern is recorded for the titanium-ruthenium co-doped vanadium dioxide film sample VTRO-21. Referring to FIG. 2.1-2, the titanium-ruthenium co-doped vanadium dioxide film sample VTRO-21 has obvious monoclinic VO₂ diffraction peaks, which means the film remains polycrystalline characteristics of the VO₂ film with the monoclinic structure. Element percentages of the titanium-ruthenium co-doped vanadium dioxide film sample VTRO-21 are analyzed through EDS, which are respectively titanium 5.9%, ruthenium 0.5%, vanadium 28.7% and oxygen 64.9%.

### Preferred Embodiment 2.2

pre-heating a quartz substrate in a sputtering vacuum chamber for 60 min at 135° C.; respectively pre-sputtering a titanium target with a purity of 99.9%, a ruthenium target with a purity of 99.9% and a vanadium target with a purity of 99.9% in a pure argon atmosphere for 10 min with a working pressure of 1.0 Pa; in an atmosphere with an oxygen-argon flow ratio of 1:25, depositing a titanium-ruthenium co-doped vanadium oxide layer on the pre-heated substrate by sputtering under a working pressure of 2.0 Pa for 50 min; and annealing the titanium-ruthenium co-doped vanadium oxide layer in an oxygen-enriched atmosphere with an oxygen-argon flow ratio of 10:1, a vacuum chamber pressure of 2.0 Pa, an annealing temperature of 380° C., and an annealing time of 60 min; then cooling to below 85° C. and taking out a sample for obtaining a titanium-ruthenium co-doped vanadium dioxide film (marked as VTRO-22).

A resistivity (ρ)-temperature (T) plot is obtained for the titanium-ruthenium co-doped vanadium dioxide film sample VO-22by measuring the ρ at different temperature. Referring to FIG. 2.2-1, a resistivity at 30° C. is shown in Table 2.2, wherein according to tested ρ-T data, a temperature coefficient of resistance |TCR| is calculated by the formula

$$TCR = \frac{dln ρ}{dT} .$$

|TCR| at 30° C. is shown in Table 2.2.

TABLE 2.2
parameters of titanium-ruthenium co-doped vanadium dioxide film
prepared according to preferred embodiment 2.2

| sample | \|TCR\| (%/° C.) | Resistivity (Ω · cm) |
|---|---|---|
| VTRO-22 | 3.3 | 3.4 |

It can be concluded that: compared to the non-doped vanadium dioxide thermosensitive film sample (VO-11), semiconductor-metal phase transition of the titanium-ruthenium co-doped vanadium dioxide film sample (VTRO-22) obtained in the preferred embodiment 2.2is suppressed, wherein no phase transition characteristic is shown, the temperature coefficient of resistance is significantly improved, and the resistivity is significantly reduced.

Furthermore, the XRD pattern is recorded for the titanium-ruthenium co-doped vanadium dioxide film sample VTRO-22. Referring to FIG. 2.2-2, the titanium-ruthenium co-doped vanadium dioxide film sample VTRO-22 has obvious monoclinic VO₂ diffraction peaks, which means the film remains polycrystalline characteristics of the VO₂ film with the monoclinic structure. Element percentages of the titanium-ruthenium co-doped vanadium dioxide film sample VTRO-22 are analyzed through EDS, which are respectively titanium 6.0%, ruthenium 0.7%, vanadium 27.9% and oxygen 65.4%.

### Preferred Embodiment 2.3

pre-heating a K9 glass substrate in a sputtering vacuum chamber for 40 min at 150° C.; respectively pre-sputtering a titanium target with a purity of 99.1%, a ruthenium target with a purity of 99.3% and a vanadium target with a purity of 99.7% in a pure argon atmosphere for 5 min with a working pressure of 1.5 Pa; in an atmosphere with an oxygen-argon flow ratio of 1:35, depositing a titanium-ruthenium co-doped vanadium oxide layer on the pre-heated substrate (the K9 glass substrate) by sputtering under a working pressure of 1.5 Pa for 50 min; and annealing titanium-ruthenium co-doped the vanadium oxide layer in an oxygen-enriched atmosphere with an oxygen-argon flow ratio of 1:0, a vacuum chamber pressure of 3.0 Pa, an annealing temperature of 400° C., and an annealing time of 30 min; then cooling to below 85° C. and taking out a sample for obtaining a titanium-ruthenium co-doped vanadium dioxide film (marked as VTRO-23).

A resistivity (ρ)-temperature (T) plot is obtained for the titanium-ruthenium co-doped vanadium dioxide film sample VO-23by measuring the ρ at different temperature. Referring to FIG. 2.3-1, a resistivity at 30° C. is shown in Table 2.3, wherein according to tested ρ-T data, a temperature coefficient of resistance |TCR| is calculated by the formula

$$TCR = \frac{dln ρ}{dT} .$$

|TCR| at 30° C. is shown in Table 2.3.

TABLE 2.3
parameters of titanium-ruthenium co-doped vanadium dioxide film
prepared according to preferred embodiment 2.3

| sample | \|TCR\| (%/° C.) | Resistivity (Ω · cm) |
|---|---|---|
| VTRO-23 | 3.4 | 1.9 |

It can be concluded that: compared to the non-doped vanadium dioxide thermosensitive film sample (VO-11), semiconductor-metal phase transition of the titanium-ruthenium co-doped vanadium dioxide film sample (VTRO-23) obtained in the preferred embodiment 2.3is suppressed, wherein no phase transition characteristic is shown, the temperature coefficient of resistance is significantly improved, and the resistivity is significantly reduced.

Furthermore, the XRD pattern is recorded for the titanium-ruthenium co-doped vanadium dioxide film sample VTRO-23. Referring to FIG. 2.3-2, the titanium-ruthenium co-doped vanadium dioxide film sample VTRO-23 has obvious monoclinic VO₂ diffraction peaks, which means the film remains polycrystalline characteristics of the VO₂ film with the monoclinic structure. Element percentages of the titanium-ruthenium co-doped vanadium dioxide film sample VTRO-23 are analyzed through EDS, which are respectively titanium 6.2%, ruthenium 0.8%, vanadium 29.1% and oxygen 63.9%.

What is claimed is:

1. A titanium-ruthenium co-doped vanadium dioxide thermosensitive film material, wherein:
titanium and ruthenium are used as co-dopants for preparing the titanium-ruthenium co-doped vanadium dioxide thermosensitive film material.

2. The titanium-ruthenium co-doped vanadium dioxide thermosensitive film material, as recited in claim 1, comprising:
a substrate and a titanium-ruthenium co-doped vanadium dioxide layer, wherein the titanium-ruthenium co-doped vanadium dioxide layer is deposited on the substrate, comprising the titanium, the ruthenium, vanadium and oxygen; wherein atomic percentages of the titanium, the ruthenium and the vanadium are respectively 4.0-7.0%, 0.5-1.5% and 25.0-30.0%, and a balance is the oxygen.

3. The titanium-ruthenium co-doped vanadium dioxide thermosensitive film material, as recited in claim 2, wherein:
the substrate is a high-purity quartz substrate, a Si substrate with a SiO₂ film, a Si substrate with a SiNₓ film, or a K9 glass substrate.

4. A preparation method of a titanium-ruthenium co-doped vanadium dioxide thermosensitive film material, comprising a step of:
using titanium and ruthenium as co-dopants for preparing; wherein specifically, using a titanium-ruthenium-vanadium alloy target as a source material and using a reactive sputtering method for preparing the vanadium dioxide thermosensitive film material with no phase transition, a low resistivity and a high temperature coefficient of resistance; or using a titanium target, a ruthenium target and a vanadium target as sputtering sources and using a co-reactive sputtering method for preparing the vanadium dioxide thermosensitive film material with no phase transition, the low resistivity and the high temperature coefficient of resistance.

5. The preparation method, as recited in claim 4, wherein:
using the titanium-ruthenium-vanadium alloy target as the source material and using the reactive sputtering method for preparing the vanadium dioxide thermosensitive film material with no phase transition, the low resistivity and the high temperature coefficient of resistance specifically comprises steps of:
1) pre-heating a substrate in vacuum for 40-400 min at 100-150° C.;
2) pre-sputtering the titanium-ruthenium-vanadium alloy target in a pure argon atmosphere for 5-15 min with a working pressure of 0.5-1.5 Pa;
3) in an atmosphere with an oxygen-argon flow ratio of 1:15-1:30, depositing a titanium-ruthenium co-doped vanadium oxide layer on the substrate pre-heated in the step 1) by sputtering the titanium-ruthenium-vanadium alloy target under a working pressure of 1.5-2.5 Pa, wherein a deposition time depends on a deposition rate and a desired film thickness; and
4) annealing the titanium-ruthenium co-doped vanadium oxide layer deposited in the step 3) in an oxygen-enriched atmosphere with an oxygen-argon flow ratio of 2:1-1:0, a vacuum chamber pressure of 1.0-3.0 Pa, an annealing temperature of 350-400° C., and an annealing time of 30-90 min; then obtaining the titanium-ruthenium co-doped vanadium dioxide thermosensitive film material after annealing.

6. The preparation method, as recited in claim 5, wherein:
in the titanium-ruthenium-vanadium alloy target, atomic percentages of the titanium and the ruthenium is 6.0-9.0% and 1.0-3.0%, and a balance is vanadium.

7. The preparation method, as recited in claim 4, wherein:
using the titanium target, the ruthenium target and the vanadium target as the sputtering sources and using the co-reactive sputtering method for preparing the vanadium dioxide thermosensitive film material with no phase transition, the low resistivity and the high temperature coefficient of resistance specifically comprises steps of:
1) pre-heating a substrate in vacuum for 40-400 min at 100-150° C.;
2) respectively pre-sputtering the titanium target, the ruthenium target and the vanadium target in a pure argon atmosphere for 5-15 min with a working pressure of 0.5-1.5 Pa;
3) in an atmosphere with an oxygen-argon flow ratio of 1:20-1:35, synchronously sputtering the titanium target, the ruthenium target and the vanadium target under a working pressure of 1.0-2.0 Pa, so as to deposit a titanium-ruthenium co-doped vanadium oxide layer on the substrate pre-heated in the step 1), wherein a deposition time depends on a deposition rate and a desired film thickness; and
4) annealing the titanium-ruthenium co-doped vanadium oxide layer deposited in the step 3) in an oxygen-enriched atmosphere with an oxygen-argon flow ratio of 5:1-1:0, a vacuum chamber pressure of 1.5-3.0 Pa, an annealing temperature of 350-400° C., and an annealing time of 30-90 min; then obtaining the titanium-ruthenium co-doped vanadium dioxide thermosensitive film material after annealing.

8. The preparation method, as recited in claim 5, wherein:
the substrate is a high-purity quartz substrate, a Si substrate with a SiO₂ film, a Si substrate with a SiNₓ film, or a K9 glass substrate.

9. The preparation method, as recited in claim 6, wherein:
the substrate is a high-purity quartz substrate, a Si substrate with a SiO₂ film, a Si substrate with a SiNₓ film, or a K9 glass substrate.

10. The preparation method, as recited in claim 7, wherein:
the substrate is a high-purity quartz substrate, a Si substrate with a SiO₂ film, a Si substrate with a SiNₓ film, or a K9 glass substrate.

11. The preparation method, as recited in claim 7, wherein purities of the titanium target, the ruthenium target and the vanadium target are no less than 99.0%.
